(19) United States
(12) Patent Application Publication
(10) Pub. No.: US 2024/0074024 A1
(43) Pub. Date: Feb. 29, 2024

(54) STEERED INDUCTIVELY COUPLED PLASMA

(71) Applicant: PERKINELMER SCIENTIFIC CANADA ULC, Woodbridge (CA)

(72) Inventors: Brian Chan, Unionville (CA); Joshua O. Oseh, Toronto (CA)

(21) Appl. No.: 17/822,843

(22) Filed: Aug. 29, 2022

(51) Int. Cl. H05H 1/00; H01J 49/10; H05H 1/30

(52) U.S. Cl. CPC H05H 1/01; H01J 49/105; H05H 1/30

(57) ABSTRACT

An inductively coupled plasma (ICP) torch includes: an injector defining an injector flow passage to receive a flow of a sample fluid; a plurality of tubes disposed about the injector and configured to receive and direct a flow of one or more torch gases; an induction device disposed about the plurality of tubes, the induction device configured to receive a radio-frequency electric current to inductively energize at least one of the one or more torch gases to produce a plasma proximate a distal end of the ICP torch; and a plasma steering system including a plurality of nozzles adjacent a distal end of the injector flow passage and configured to receive and direct a flow of steering fluid to impinge and redirect the flow of sample fluid and to thereby redirect an ionized sample resulting from the interaction of the sample fluid with the plasma.

### FIELD

The present technology relates to plasma sources and, more particularly, to inductively coupled plasma torches.

### BACKGROUND

Some inductively coupled plasma (ICP) devices use a positioning stage to align an ICP torch to another element such as a mass spectroscopy (MS) interface. Drive mechanisms such as motors are used to adjust the stage and therefore the direction of the plasma exiting the torch.

### SUMMARY

Some embodiments of the present technology are directed to inductively coupled plasma (ICP) torch or ICP torch system including: an injector defining an injector flow passage to receive a flow of a sample fluid; a plurality of tubes disposed about the injector and configured to receive and direct a flow of one or more torch gases; an induction device disposed about the plurality of tubes, the induction device configured to receive a radio-frequency electric current to inductively energize at least one of the one or more torch gases to produce a plasma proximate a distal end of the ICP torch; and a plasma steering system including a plurality of nozzles adjacent a distal end of the injector flow passage and configured to receive and direct a flow of a steering fluid to impinge and redirect the flow of the sample fluid and to thereby redirect an ionized sample resulting from an interaction of the sample fluid with the plasma.

In some embodiments, each nozzle is angled toward the flow of the sample fluid as the sample fluid exits the distal end of the injector flow passage.

In some embodiments, the plasma steering system is configured to deflect the flow of the sample fluid along one or more axes perpendicular to a longitudinal axis of the injector flow passage.

In some embodiments, the ICP torch is free of a translation stage configured to displace the ICP torch along one or more axes perpendicular to a longitudinal axis of the injector flow passage.

In some embodiments, the ICP torch is fixed and stationary in every direction perpendicular to a longitudinal axis of the injector flow passage.

In some embodiments, the plasma steering system is configured to selectively flow the steering fluid through each of the plurality of nozzles. The plasma steering system may be configured to select an amount and/or a flow rate of the steering fluid through each of the plurality of nozzles.

In some embodiments, the injector includes a body, and the plurality of nozzles are defined in the body.

In some embodiments, the plasma steering system includes a steering fluid passage for each nozzle, and each steering fluid passage includes an inlet portion and an intermediate portion between the inlet portion and the nozzle. Each steering fluid passage may be defined in the body. The inlet portion may be at a proximal end portion of the injector. The intermediate portion may extend along a major portion of a length of the injector. A major portion of the intermediate portion may be substantially parallel to the injector flow passage.

In some embodiments, the plurality of nozzles are angled with respect to a longitudinal axis of the injector flow passage. The injector flow passage may define an injector flow passage longitudinal axis, each nozzle may define a nozzle longitudinal axis, and an angle between the injector flow passage longitudinal axis and each nozzle longitudinal axis may be between 1 degree and 10 degrees.

In some embodiments, the plasma steering system includes a manifold including a plurality of inlets in fluid communication with corresponding ones of the plurality of nozzles.

In some embodiments, a steering fluid source containing the steering fluid and in fluid communication with the plurality of inlets.

In some embodiments, the steering fluid includes argon.

In some embodiments, the plasma steering system includes a plurality of valves with one each in fluid communication with a corresponding inlet. The plasma steering system or a controller associated therewith may be configured to control the valves independently to control an amount and/or a flow rate of the steering fluid provided to each of the nozzles.

In some embodiments, the plurality of nozzles include at least three nozzles.

In some embodiments, the plurality of nozzles include at least four nozzles.

In some embodiments, the plurality of nozzles are circumferentially disposed around the injector flow passage.

In some embodiments, the plurality of nozzles are equally spaced apart circumferentially around the injector flow passage.

In some embodiments, the plurality of tubes include: an intermediate tube disposed about the injector, wherein the injector and the intermediate tube define an auxiliary gas passage configured to receive a flow of an auxiliary gas; and a plasma tube disposed about the intermediate tube, wherein the intermediate tube and the plasma tube define a plasma gas passage configured to receive a flow of a plasma gas.

In some embodiments, the induction device is configured to receive the radio-frequency electric current to inductively energize the auxiliary gas to produce the plasma proximate the distal end of the torch.

Some other embodiments of the present technology are directed to a method for conducting a mass analysis of a sample. The method includes providing a mass analysis system including: an inductively coupled plasma (ICP) torch including an injector configured to provide a flow of a sample fluid, the ICP torch configured to generate a plasma that ionizes the sample fluid to form an ionized sample; a sample introduction element including an orifice; and a steering fluid system operatively associated with the ICP torch and including a plurality of nozzles at a distal end of the injector. The method includes injecting a steering fluid from at least one of the plurality of nozzles into the flow of the sample fluid as the sample fluid exits the injector to deflect the flow of the sample fluid to thereby align the ionized sample with the orifice.

In some embodiments, the injecting the steering gas includes selectively and independently controlling an amount and/or a flow rate of the steering fluid injected from each of the plurality of nozzles.

Some other embodiments of the present technology are directed to a mass analysis system including: an inductively coupled plasma (ICP) torch including an injector configured to provide a flow of the sample fluid, the ICP torch configured to generate a plasma that ionizes the sample fluid to form an ionized sample; a sample introduction element including an orifice; and a steering fluid system operable to selectively align the ionized sample with the orifice. The steering fluid system may include a plurality of nozzles at a distal end of the injector and configured to inject the steering fluid toward the flow of the sample fluid to impinge and redirect the flow of the sample fluid.

In some embodiments, the mass analysis system is an ICP mass spectrometry (ICP-MS) system, an ICP optical emission spectrometry (ICP-OES) system, or an ICP atomic absorption spectrometry (ICP-AAS) system.

Some other embodiments of the present technology are directed to an injector assembly for an inductively coupled plasma (ICP) torch. The injector assembly includes: an injector defining an injector flow passage configured to receive a flow of a sample fluid; and a plurality of nozzles adjacent a distal end of the injector flow passage configured to receive a flow of a steering fluid and inject the steering fluid to impinge and redirect the flow of the sample fluid.

In some embodiments, each nozzle is angled toward the flow of the sample fluid as the sample fluid exits the distal end of the injector flow passage.

In some embodiments, the plurality of nozzles are configured to deflect the flow of the sample fluid along one or more axes perpendicular to a longitudinal axis of the injector flow passage.

In some embodiments, the injector includes a body, and the plurality of nozzles are defined in the body.

In some embodiments, the plurality of nozzles are circumferentially disposed around the injector flow passage.

In some embodiments, the plurality of nozzles include at least three nozzles.

In some embodiments, the plurality of nozzles include at least four nozzles.

In some embodiments, the plurality of nozzles are equally spaced apart circumferentially around the injector flow passage.

In some embodiments, each of the plurality of nozzles is at a distal end of a dedicated steering fluid passage defined in the body.

In some embodiments, a major portion of each steering fluid passage extends substantially parallel to the injector flow passage.

In some embodiments, each steering fluid passage comprises an entrance or inlet at a proximal end portion of the injector body.

In some embodiments, the injector flow passage defines an injector flow passage longitudinal axis, each nozzle defines a nozzle longitudinal axis, and an angle between the injector flow passage longitudinal axis and each nozzle longitudinal axis is between 1 degree and 10 degrees.

In some embodiments, each of the nozzles has a diameter between 0.5 mm and 2 mm.

Further features, advantages and details of the present technology will be appreciated by those of ordinary skill in the art from a reading of the figures and the detailed description of the embodiments that follow, such description being merely illustrative of the present technology.

### BRIEF DESCRIPTION OF THE DRAWINGS

The accompanying drawings, which form a part of the specification, illustrate embodiments of the technology.

FIG. 1 is a perspective view of an ICP torch system according to some embodiments.

FIG. 2 is a sectional view of the ICP torch system of FIG. 1.

FIG. 3 is a schematic section view of the ICP torch system of FIG. 1.

FIG. 4 is a sectional view of an injector of the of the ICP torch system of FIG. 1.

FIG. 5 is an enlarged sectional view of a distal end portion of the injector of FIG. 4.

FIG. 6 is an end view of the injector of FIG. 4.

FIG. 7 is an end view of the injector of FIG. 4 according to further embodiments.

FIG. 8 is a block diagram illustrating a steering fluid system according to some embodiments.

FIG. 9 is a schematic side view of a mass analysis system according to some embodiments.

### DETAILED DESCRIPTION

Conventional ICP torches used with MS devices include a torch positioning system including a stage that is adjusted using motors. The stage (sometimes called an X-Y stage) is adjusted to align plasma or an ionized sample with an interface or orifice in the device. The inventors have recognized and appreciated that the stage, the motors, and associated components (e.g., gears, linkages, etc.) add to the number of parts and the cost of the device. Moreover, mechanical motion controls such as gears, motors, and linkages can deteriorate over time, requiring replacement or service.

The inventors have recognized and appreciated that the plasma created by an ICP torch can be steered without some or all of these mechanical components, thereby reducing the cost, complexity and/or number of parts of the apparatus. In particular, the inventors have recognized and appreciated that a steering fluid may be used to redirect the flow of sample fluid to thereby redirect (i.e., steer) an ionized sample and align it with an interface or orifice (e.g., an inlet of a sample introduction element). As a result, apparatus and methods according to embodiments of the technology can make the use of components such as motor unnecessary and therefore reduce the cost of the device. While some embodiments may address some or all of the shortcomings of conventional ICP torches, some embodiments may not address every shortcoming. For example, in some embodiments, mechanical motion controls may be used in addition to a steering fluid to position the plasma generated by an ICP torch.

In some embodiments, an ICP torch or ICP torch system includes an injector defining an injector flow passage to receive a flow of sample gas, a plurality of tubes disposed about the injector and configured to receive and direct a flow of one or more torch gases, an induction device disposed about or adjacent the plurality of tubes, the induction device configured to receive a radio-frequency electric current to inductively energize at least one of the one or more torch gases to produce a plasma proximate a distal end of the ICP torch, and a plasma steering system including a plurality of nozzles adjacent a distal end of the injector flow passage and configured to receive and direct a flow of steering fluid to impinge and redirect the flow of sample fluid and to thereby redirect an ionized sample resulting from the interaction of the sample fluid with the plasma.

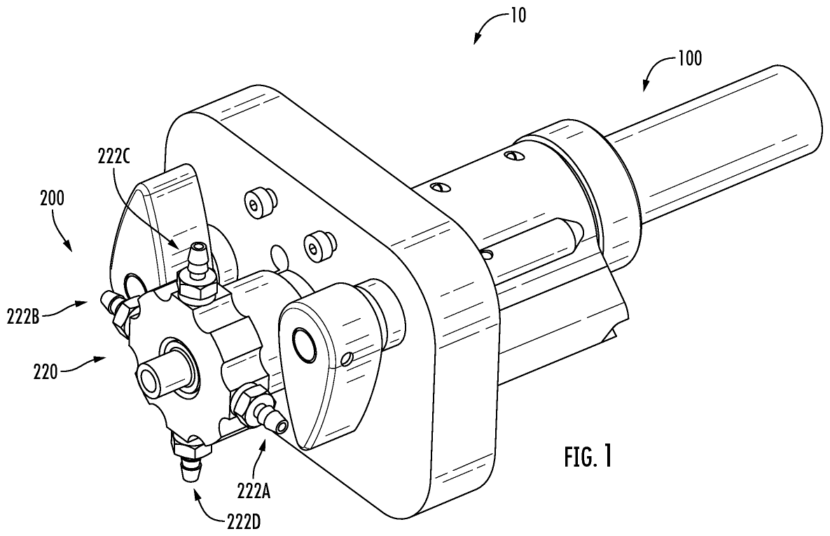

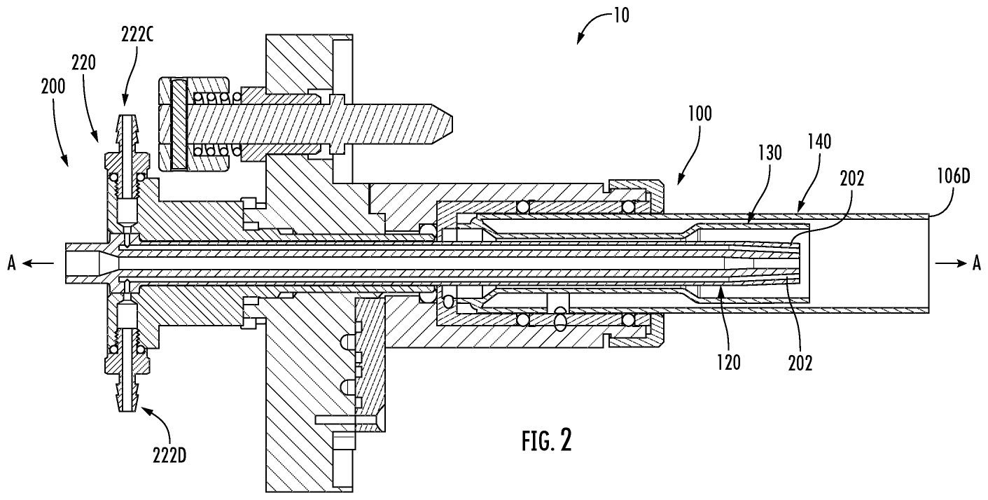

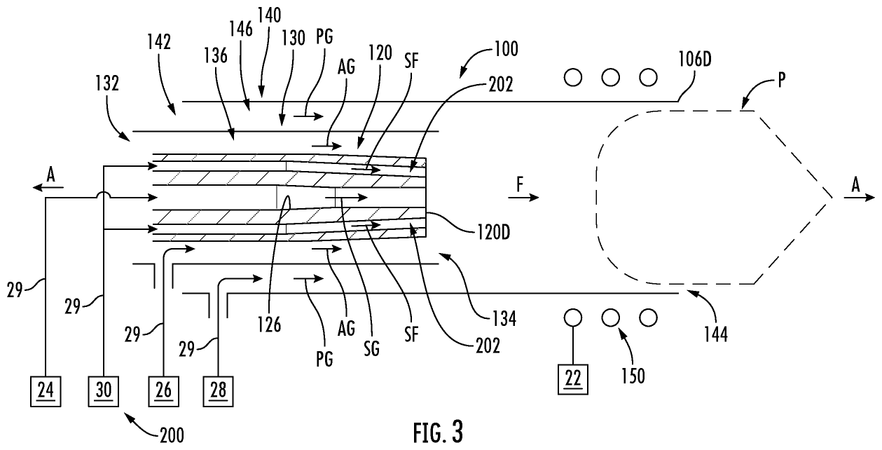

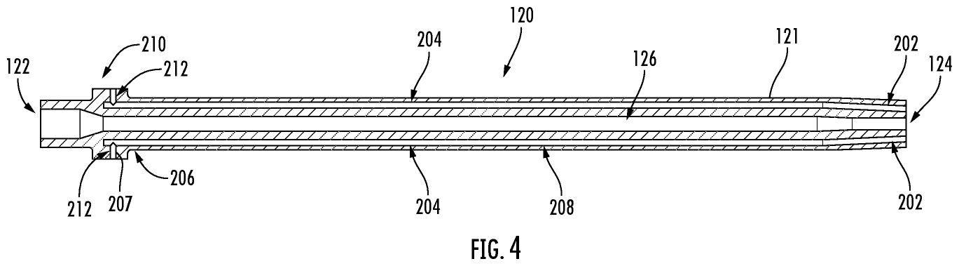

FIG. 1 is a perspective view of an ICP torch system 10 according to some embodiments. FIG. 2 is a sectional view of the ICP torch system 10 of FIG. 1. FIG. 3 is a schematic sectional view of the ICP torch system 10 of FIG. 1. FIG. 4 is a sectional view of an injector of the ICP torch system 10 of FIG. 1. With reference to FIGS. 1-4, the ICP torch system 10 includes a torch 100, a sample source 24, an auxiliary gas source 26, a plasma gas source 28, and a steering fluid source 30. In use, a sample flow or stream SG (from the sample source 24), an auxiliary gas flow or stream AG (from the auxiliary gas source 26), a plasma gas flow or stream PG (from the plasma gas source 28), and a steering fluid flow or stream SF (from the steering fluid source 30) are each forced or flowed through the torch 100 in a forward direction F toward a distal end 106D of the torch 100. The ICP torch system 10 generates a plasma P at the distal end 106D from the auxiliary gas AG.

The plasma P may serve as an ionization source. In some embodiments, the plasma P decomposes a sample from the sample stream SG into its constituent elements and transforms those elements into ions. The sample may be an analyte of interest.

The sample source 24 may include a supply of a sample to be analyzed. The sample of interest may be provided in a solution or mixture. The sample source 24 may include an injector, nebulizer or other suitable device configured to deliver solid, liquid, or gaseous samples to the torch 100.

The auxiliary gas source 26 may include a supply of the auxiliary gas AG. The auxiliary gas AG may be any suitable gas from which the plasma P can be formed or generated as described herein. In some embodiments, the auxiliary gas AG is argon gas. In other embodiments, the auxiliary gas AG is nitrogen gas. The auxiliary gas source 26 is configured to provide a pressurized supply and flow of the auxiliary gas AG to the torch 100. The auxiliary gas source 26 may include a flow generator (e.g., a pump) and/or may contain a positively pressurized supply of the auxiliary gas AG.

The plasma gas source 28 may include a supply of the plasma gas PG. The plasma gas PG may be any suitable gas for serving the functions as described herein. In some embodiments, the plasma gas PG and the auxiliary gas AG have the same gas composition. In some embodiments, the plasma gas PG is argon gas. In other embodiments, the plasma gas PG is nitrogen gas. The plasma gas source 28 is configured to provide a pressurized supply and flow of the plasma gas PG to the torch 100. The plasma gas source 28 may include a flow generator (e.g., a pump) and/or may contain a positively pressurized supply of the plasma gas PG.

The steering fluid source 30 may include a supply of the steering fluid or steering gas SF. The steering fluid SF may be any suitable gas for serving the functions as described herein. In some embodiments, the steering fluid SF is argon gas. In other embodiments, the steering fluid SF is nitrogen gas. The steering fluid source 30 is configured to provide a pressurized supply and flow of the steering fluid SF to the torch 100. The steering fluid source 30 may include a flow generator (e.g., a pump) and/or may contain a positively pressurized supply of the steering fluid SF.

The torch 100 has a torch longitudinal axis A-A. The torch 100 includes an induction device 150. The induction device 150 may include a coil as illustrated. In some other embodiments, the induction device 150 includes plates. In other embodiments, the induction device 150 may include a combination of plates and coils.

The torch 100 includes an injector 120, an intermediate tube 130, and a plasma tube 140. The intermediate tube 130 circumferentially surrounds the injector 120, and the plasma tube 140 circumferentially surrounds the intermediate tube 130. In some embodiments, the injector 120, the intermediate tube 130, and the plasma tube 140 are substantially concentric about the torch axis A-A.

The injector 120 may be formed of suitable material. In some embodiments, the injector tube 120 is formed of quartz, sapphire, or platinum.

The auxiliary tube 130 may be formed of suitable material. In some embodiments, the auxiliary tube 130 is formed of quartz.

The plasma tube 140 may be formed of suitable material. In some embodiments, the plasma tube 140 is formed of quartz.

The injector 120 has an inlet 122 and an outlet 124. The intermediate tube 130 has an inlet 132 and an outlet 134. The plasma tube 140 has an inlet 142 and an outlet 144.

The injector 120 defines an axially extending injector flow passage or sample passage 126 fluidly connecting the inlet 122 and the outlet 124. The injector 120 and the intermediate tube 130 define an axially extending auxiliary gas passage 136 between the opposing surfaces of the injector 120 and the intermediate tube 130. The auxiliary gas passage 136 fluidly connects the inlet 132 and the outlet 134. The intermediate tube 130 and the plasma tube 140 define an axially extending gas passage 146 between the opposing surfaces of the intermediate tube 130 and the plasma tube 140. The plasma gas passage 146 fluidly connects the inlet 142 and the outlet 144.

The sample source 24, the auxiliary gas source 26, and the plasma gas source 28 may be fluidly coupled to the inlet 122, the inlet 132, and the inlet 142, respectively, by corresponding conduits 29.

The induction device 150 may be electrically connected to a radio-frequency (RF) power supply 22. The RF power supply may be configured to provide RF energy or electric current into and through the induction device 150. In some embodiments, the induction device 150 includes coil(s) and/or plate(s). In some embodiments, the induction device 150 is formed of a suitable material, such as copper or aluminum.

In use, the sample gas SG is flowed through the sample gas passage 126, the auxiliary gas AG is flowed through the auxiliary gas passage 136, and the plasma gas PG is flowed through the plasma gas passage 146 in the direction F. It will be appreciated that the auxiliary gas stream AG is segregated from the sample gas stream SG by the injector tube 120 until the injector tube outlet 124, and is segregated from the plasma gas stream PG by the intermediate tube 130 until the outlet 134.

The induction device 150 is powered to inductively heat the auxiliary gas stream AG. An electric spark may be applied for a short time to introduce free electrons into the auxiliary gas stream AG. The auxiliary gas AG is thereby energized into a plasma P. The sample gas stream SG may enter the plasma P, where the sample gas stream evaporates and the molecules of the sample of interest break apart and the constituent atoms ionize.

The torch system 10 further includes a plasma steering system 200. The plasma steering system includes a plurality of nozzles 202 adjacent a distal or terminal end 120D of the injector 120. As described in more detail below, the nozzles 202 are configured to receive and direct a flow of the steering fluid SF to impinge and redirect the flow of sample fluid SG and to thereby redirect an ionized sample resulting from the interaction of the sample fluid SG with the plasma P. As described in more detail below, there may be at least three or at least four nozzles in various embodiments.

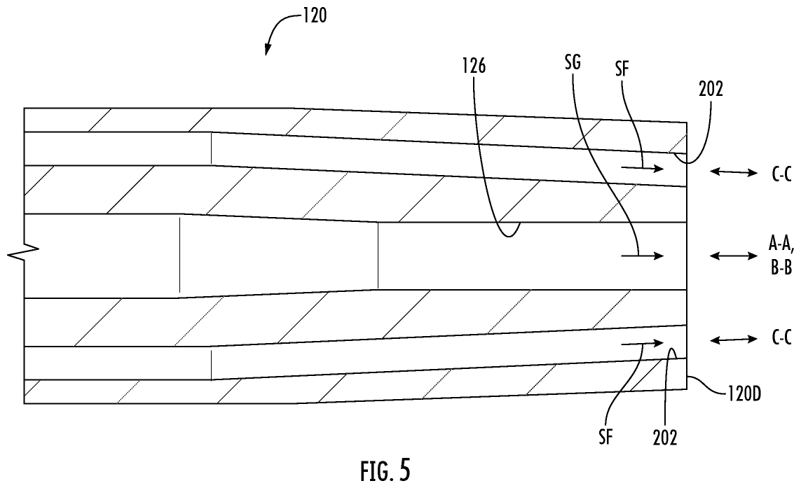

Referring to FIG. 5, each nozzle 202 may be angled toward the flow of the sample fluid as the sample fluid SG exits the distal end 120D of the injector 120. The injector 120 or the injector flow passage 126 defines a longitudinal axis B-B. The longitudinal axis B-B of the injector flow passage 126 may be coaxial or substantially coaxial with the longitudinal axis A-A of the torch 100. As described herein, the plasma steering system may be configured to deflect the flow of the sample fluid along one or more axes perpendicular to the longitudinal axis B-B of the injector flow passage.

Each nozzle 202 may define a longitudinal axis C-C. An angle between the injector flow passage longitudinal axis B-B and each nozzle longitudinal axis C-C may be between 1 degree and 60 degrees, between 10 degrees and 60 degrees, between 15 degrees and 55 degrees, between 25 degrees and 55 degrees, between 35 degrees and 55 degrees, between 40 degrees and 50 degrees, and about 45 degrees in various embodiments. An angle between the injector flow passage longitudinal axis B-B and each nozzle longitudinal axis C-C may be between 1 degree and 30 degrees, between 1 degree and 15 degrees, between 1 degree and 10 degrees, between 1 degree and 5 degrees, and about 2.5 degrees in various embodiments.

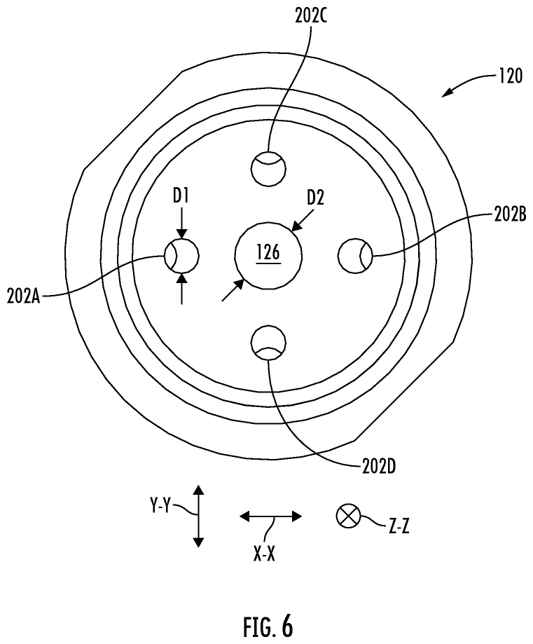

FIG. 6 illustrates an example wherein the plurality of nozzles 202 includes four nozzles 202A, 202B, 202C, 202D. The plurality of nozzles 202A, 202B, 202C, 202D may be circumferentially disposed around the injector flow passage 126. The plurality of nozzles 202A, 202B, 202C, 202D may be equally spaced apart circumferentially around the injector flow passage 126. Each of the nozzles 202A, 202B, 202C, 202D may have a diameter D1 between 0.1 mm and 4 mm, between 0.3 mm and 3 mm, between 0.5 mm and 2 mm, between 0.5 mm and 1.5 mm, and about 1 mm in various embodiments. The injector flow passage may have a diameter D2 between 0.1 mm and 5 mm, between 0.2 mm and 4 mm, between 0.5 mm and 3 mm, between 0.85 mm and 2.5 mm, between 1.5 mm and 2.5 mm, and about 2 mm in various embodiments.

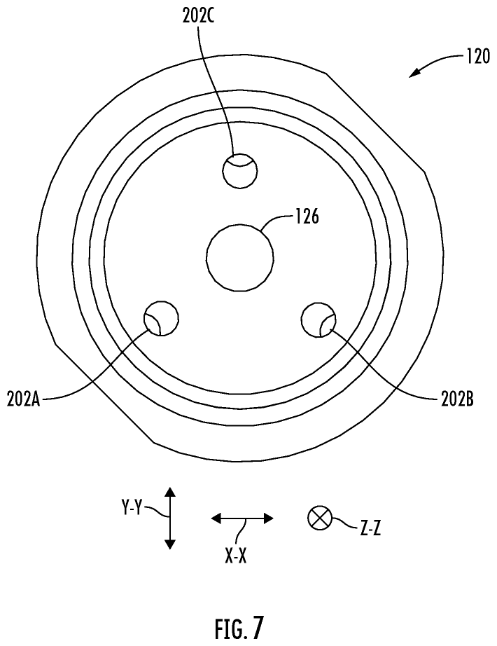

FIG. 7 illustrates an example wherein the plurality of nozzles 202 includes three nozzles 202A, 202B, 202C. The plurality of nozzles 202A, 202B, 202C may be circumferentially disposed around the injector flow passage 126. The plurality of nozzles 202A, 202B, 202C may be equally spaced apart circumferentially around the injector flow passage 126. While FIG. 6 illustrates an embodiment with four nozzles and FIG. 7 illustrates an embodiment with three nozzles, it should be appreciated that any number of nozzles can be used. Additionally, it should be appreciated that every nozzle has a corresponding steering fluid passage for providing steering fluid, from the steering fluid source, to the associated nozzle.

Referring again to FIG. 4, the injector 120 includes a body 121 and the nozzles 202 may be defined in the body 121. There may be a steering fluid passage 204 for each nozzle 202, and each steering fluid passage 204 may be defined in the body 121. That is, each nozzle 202 may have a dedicated steering fluid passage 204 associated therewith. Each steering fluid passage 204 may include an entrance portion or inlet portion 206 and an intermediate portion 208 between the inlet portion 206 and the nozzle 202. In some embodiments, the inlet portion 206 is at a proximal end portion 210 of the injector 120.

The intermediate portion 208 of each steering fluid passage may extend along a major portion of a length of the injector 120. In some embodiments, at least a major portion of the intermediate portion 208 is substantially parallel to the injector flow passage 126.

Each steering fluid passage 204 may include an entrance 207 that may be perpendicular to or substantially perpendicular to the intermediate portion 208. The intermediate portion 208 may extend between the nozzle 202 and the entrance 207.

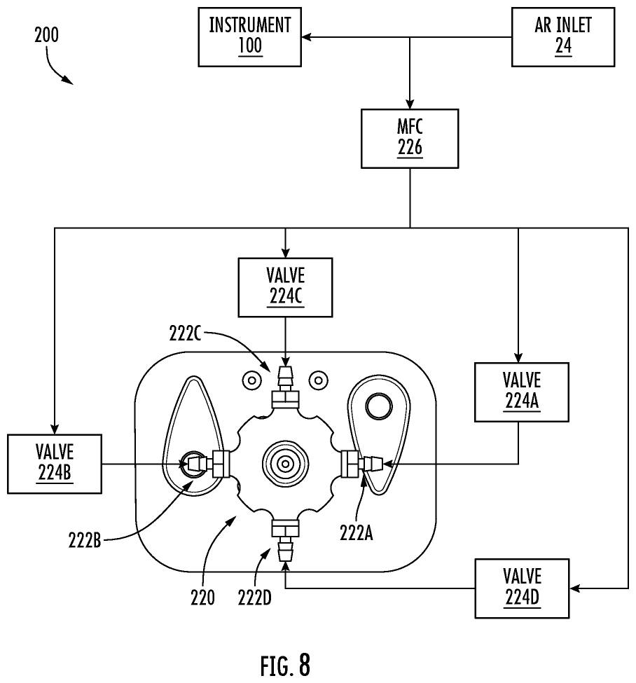

Referring to FIGS. 1, 2, and 8, the plasma steering system 200 may include a manifold 220 including a plurality of (steering fluid) inlets 222A, 222B, 222C, 222D in fluid communication with corresponding ones of the plurality of nozzles 202A, 202B, 202C, 202D (FIG. 6). A steering fluid source is in fluid communication with the plurality of inlets 222A, 222B, 222C, 222D. As shown in FIG. 8, the sample gas source 24 may be used to provide both the sample gas flow SG and the steering fluid flow SF (FIG. 3). The separate steering fluid source 30 of FIG. 3 may be omitted with such an arrangement.

The plasma steering system 200 may include a plurality of valves 224A, 224B, 224C, 224D with one each in fluid communication with a corresponding inlet 222A, 222B, 222C, 222D.

The plasma steering system 200 may include a controller 226. The controller 226 may be or include a mass flow controller. The controller 226 may be configured to control the valves 224A, 224B, 224C, 224D independently to control the amount and/or flow rate of steering fluid provided to each of the nozzles.

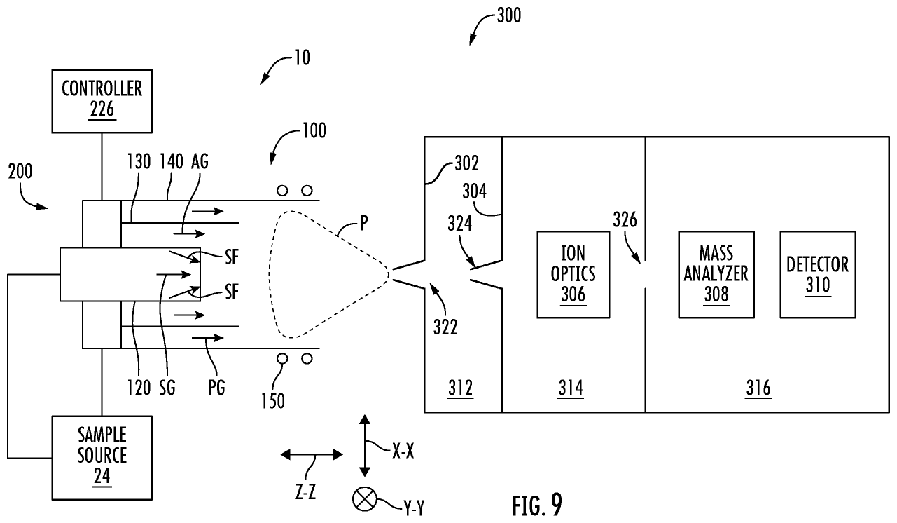

With reference to FIG. 9, a torch system 10 as described herein may be incorporated into a mass analyzer system 300. The illustrated mass analyzer system 300 is an inductively coupled plasma mass spectroscopy (ICP-MS) analyzer. The ICP-MS analyzer system 300 may be constructed and operated as disclosed in U.S. Pat. No. 9,105,457 to Badiei et al., for example, the disclosure of which is incorporated herein by reference.

The mass analyzer system 300 includes the plasma steering system 200, the torch system 10, the sample source 24, a sampler 302, a skimmer 304, ion optics 306, a mass analyzer 308, a detector 310, an interface vacuum chamber 312, an ion optics vacuum chamber 314, a mass analyzer vacuum chamber 316, and the controller 226.

The torch assembly 10 includes the ICP torch 100. The torch 100 includes the injector 120, the intermediate or auxiliary tube 130 formed of quartz, for example), the outer or plasma tube 140, and the induction device 150 (e.g., an RF energy coil). The torch assembly 100 may further include electrical connections for the induction coil 150, a clamp or mount for securing the torch 100 to a housing, connections for introducing the sample and gas streams described herein to the torch 100, and/or other components.

The sample source 24 (e.g., a nebulizer) supplies a sample stream SG including a sample contained in a carrier gas (e.g., argon) through the injector 120 into the auxiliary tube 130. An auxiliary gas flow AG (e.g., argon) is also introduced into the auxiliary tube 130. A plasma gas flow PG (e.g., argon; typically having a higher flow rate auxiliary gas flow AG) is provided in the plasma tube 140.

In use, a plasma P is generated by the induction device 150 from the auxiliary gas flow AG. The plasma P is generated close to atmospheric pressure by the induction device 150 encircling the plasma tube 140. Plasma P can also be generated in any other suitable fashion known in the art. The plasma P atomizes the sample stream SG and ionizes the atoms, creating a mixture of ions and free electrons. A portion of the plasma P is sampled through (i.e., travels or flows through) an orifice or inlet 322 in the sampler 302. The sampler 302 and the skimmer 304 may form opposing walls of the interface vacuum chamber 312. The interface vacuum chamber 312 may be evacuated to a moderately low pressure (e.g. 1-5 Torr) by a vacuum pump. The skimmer 304 has an orifice 324 which leads to the ion optics vacuum chamber 314. The ion optics vacuum chamber 314 is evacuated to a lower pressure (e.g., 10⁻³ Torr or less) than that of the interface vacuum chamber 312. The ion optics vacuum chamber 314 includes the ion optics 306 for focusing the ion beam.

The ions emerging from the ion optics 306 travel through an orifice 326 in a wall and into the mass analyzer vacuum chamber 316. In certain embodiments, the mass analyzer vacuum chamber 316 may be part of the ion optics vacuum chamber 314. The mass analyzer 308 is disposed in the mass analyzer vacuum chamber 316 downstream of the inlet 322. The mass analyzer 308 may be a quadrupole mass spectrometer, an ion trap, a magnetic sector analyzer, a time of flight analyzer, an ion mobility analyzer, or any other suitable mass analyzer known to those of skill in the art.

In use, ions from the plasma P travel with the plasma gas through the sampler orifice 322. Ions then pass through the skimmer aperture 324, carried by the bulk gas flow. The ions are then charge separated, partly because of the diffusion of high mobility electrons and partly because of the ion optics 306 and the bias potentials thereon. The ions are focused by the ion optics 306 through orifice 326 and into the mass analyzer 308. The mass analyzer 308 is controlled to produce a mass spectrum for the sample being analyzed.

In other embodiments, the mass analyzer system 300 may include a second skimmer, e.g., as disclosed in U.S. Pat. No. 9,105,457 to Badiei et al., the disclosure of which is incorporated herein by reference in its entirety.

In order to increase the performance and detection precision of the mass analyzer system 300, the plasma P should be properly aligned with the inlet or orifice 322, which in some cases means centering the plasma P with the inlet 322 (e.g., using the plasma steering system 200) but in other cases may mean running the ICP-MS analyzer while altering the position of the plasma P with the plasma steering system 200 until the detection rate of the ICP-MS analyzer is above a desired threshold.

The plasma steering system 200 is operable to center or align the plasma P generated by the torch assembly 100, relative to the inlet or orifice 322. More particularly, the plasma steering system 200 is configured to adjust the position of the plasma P along each of the X-axis and the Y-axis (which extend perpendicular to one another and the Z-axis) as described herein.

For example, referring to FIG. 6, flowing steering fluid out of nozzle 202A and/or nozzle 202B could adjust the position of the plasma (or the ionized sample) along the X-axis. Flowing steering fluid out of nozzle 202C and/or nozzle 202D could adjust the position of the plasma (or the ionized sample) along the Y-axis. Steering fluid could be flowed out of a combination or subset of the nozzles 202A, 202B, 202C, and/or 202D, and in some embodiments, at varying flowrates, to adjust the position of the plasma (or the ionized sample) along both the X-axis and the Y-axis. In some embodiments, the plasma steering system 200 is configured to adjust the position of the plasma (or the ionized sample) along each of the X-axis and the Y-axis up to ±1 mm.

However, it will be appreciated that it may be more complex than nozzles 202A and 202B controlling deflection in the X-axis only. These nozzles may result in the steering in the Y-direction also due to, for example, the complicated fluid dynamics involved with the swirl of the plasma created by the torch. The nozzles 202C and 202D may not deflect solely in the Y-direction for similar reasons.

The steering fluid system as described herein is deterministic and repeatable. It automatically and selectively flows steering fluid through the various nozzles to deflect in the X-direction, Y-direction, or any direction by any amount.

Referring to FIG. 7, it will be appreciated that the amount and/or the flowrate of steering fluid flowing through nozzles 202A, 202B, and/or 202C may be selected to adjust the position of the plasma (or the ionized sample) along both the X-axis and the Y-axis.

Referring to FIG. 9, in some embodiments, the controller 226 programmatically and automatically controls the steering fluid system 200 to adjust and set the amount and/or flow rate of steering fluid provided to each of the nozzles to achieve an alignment. In some embodiments, the operator or the controller 226 executes a calibration procedure. In the calibration procedure, the mass analysis system is operated to generate a plasma via the torch 100 and analyze a sample (e.g., a reference sample). The controller 226 (or operator) adjusts the amount and/or flow rate of steering fluid provided to each of the nozzles while the sample is ionized by the torch 100 and monitors the detection signal from the detector 310. Based on the detection efficiency (signal optimization) at different nozzle flow arrangements, the controller 226 (or operator) determines when an optimal or desired alignment has been achieved.

Current ICP torches use a X-Y torch positioning system that rely on motors to adjust the X-Y position of the torch. In contrast, the present technology adjusts the X-Y position of the ionized sample based on fluid interaction by the sample gas and steering fluid exiting the nozzles. In some embodiments, the torch is free of a translation stage configured to displace the ICP torch along one or more axes perpendicular to a longitudinal axis of the injector flow passage. In some embodiments, the torch is fixed and stationary in every direction perpendicular to a longitudinal axis of the injector flow passage (including along the X and Y axes).

The present technology eliminates the use of motors and associated components (e.g., gears). This leads to an overall reduction in the number of parts and reduces cost.

The torch system described herein has primarily been described as being used in an ICP-MS instrument. However, it is contemplated that the torch system could be used in any instrument where a sample is injected (including ICP-OES and ICP-AAS instruments).

The present technology has been described herein with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items. When the term “about” or “substantially equal to” is used in the specification the intended meaning is that the value is plus or minus 5% of the specified value.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present technology are explained in detail in the specification set forth herein.

Unless otherwise defined, all terms (including technical and scientific terms) used herein have the same meaning as commonly understood by one of ordinary skill in the art to which this technology belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “automatically” means that the operation is substantially, and may be entirely, carried out without human or manual input, and can be programmatically directed or carried out.

The term “programmatically” refers to operations directed and/or primarily carried out electronically by computer program modules, code and/or instructions.

The foregoing is illustrative of the present technology and is not to be construed as limiting thereof. Although a few example embodiments of this technology have been described, those skilled in the art will readily appreciate that many modifications are possible in the example embodiments without materially departing from the teachings and advantages of this technology. Accordingly, all such modifications are intended to be included within the scope of this technology as defined in the claims. The technology is defined by the following claims, with equivalents of the claims to be included therein.

1. An inductively coupled plasma (ICP) torch comprising:
an injector defining an injector flow passage to receive a flow of a sample fluid;
a plurality of tubes disposed about the injector and configured to receive and direct a flow of one or more torch gases;
an induction device disposed about the plurality of tubes, the induction device configured to receive a radio-frequency electric current to inductively energize at least one of the one or more torch gases to produce a plasma proximate a distal end of the ICP torch; and
a plasma steering system comprising a plurality of nozzles adjacent a distal end of the injector flow passage and configured to receive and direct a flow of a steering fluid to impinge and redirect the flow of the sample fluid and to thereby redirect an ionized sample resulting from an interaction of the sample fluid with the plasma.

2. The ICP torch of claim 1 wherein each nozzle is angled toward the flow of the sample fluid as the sample fluid exits the distal end of the injector flow passage.

3. The ICP torch of claim 1 wherein the plasma steering system is configured to deflect the flow of the sample fluid along one or more axes perpendicular to a longitudinal axis of the injector flow passage.

4. The ICP torch of claim 1 wherein the ICP torch is free of a translation stage configured to displace the ICP torch along one or more axes perpendicular to a longitudinal axis of the injector flow passage.

5. The ICP torch of claim 1 wherein the ICP torch is fixed and stationary in every direction perpendicular to a longitudinal axis of the injector flow passage.

6. The ICP torch of claim 1 wherein the plasma steering system is configured to selectively flow the steering fluid through each of the plurality of nozzles, and wherein the plasma steering system is configured to select an amount and/or a flow rate of the steering fluid through each of the plurality of nozzles.

7. (canceled)

8. The ICP torch of claim 1 wherein the injector comprises a body, and wherein the plurality of nozzles are defined in the body.

9. The ICP torch of claim 8 wherein the plasma steering system comprises a steering fluid passage for each nozzle, and wherein each steering fluid passage comprises an inlet portion and an intermediate portion between the inlet portion and the nozzle.

10. The ICP torch of claim 9 wherein each steering fluid passage is defined in the body.

11. The ICP torch of claim 10 wherein the inlet portion is at a proximal end portion of the injector.

12. The ICP torch of claim 10 wherein the intermediate portion extends along a major portion of a length of the injector.

13. The ICP torch of claim 10 wherein a major portion of the intermediate portion is substantially parallel to the injector flow passage.

14. The ICP torch of claim 8 wherein the plurality of nozzles are angled with respect to a longitudinal axis of the injector flow passage.

15. The ICP torch of claim 14 wherein the injector flow passage defines an injector flow passage longitudinal axis, wherein each nozzle defines a nozzle longitudinal axis, and wherein an angle between the injector flow passage longitudinal axis and each nozzle longitudinal axis is between 1 degree and 10 degrees.

16. The ICP torch of claim 1 wherein the plasma steering system comprises a manifold comprising a plurality of inlets in fluid communication with corresponding ones of the plurality of nozzles.

17. The ICP torch of claim 16 further comprising a steering fluid source containing the steering fluid and in fluid communication with the plurality of inlets.

18. (canceled)

19. The ICP torch of claim 17 wherein the plasma steering system comprises a plurality of valves with one each in fluid communication with a corresponding inlet, and wherein the plasma steering system or a controller associated therewith is configured to control the valves independently to control an amount and/or a flow rate of the steering fluid provided to each of the nozzles.

20. (canceled)

21. The ICP torch of claim 1 wherein the plurality of nozzles comprise at least three nozzles.

22-28. (canceled)

29. A mass analysis system comprising:
an inductively coupled plasma (ICP) torch comprising an injector configured to provide a flow of the sample fluid, the ICP torch configured to generate a plasma that ionizes the sample fluid to form an ionized sample;
a sample introduction element including an orifice; and
a steering fluid system operable to selectively align the ionized sample with the orifice,
wherein the steering fluid system comprises a plurality of nozzles at a distal end of the injector and configured to inject the steering fluid toward the flow of the sample fluid to impinge and redirect the flow of the sample fluid.

30. (canceled)

31. An injector assembly for an inductively coupled plasma (ICP) torch, the injector assembly comprising:
an injector defining an injector flow passage configured to receive a flow of a sample fluid; and
a plurality of nozzles adjacent a distal end of the injector flow passage configured to receive a flow of a steering fluid and inject the steering fluid to impinge and redirect the flow of the sample fluid.

32-43. (canceled)
